(19) United States
(12) Patent Application Publication
(10) Pub. No.: US 2006/0080221 A1
(43) Pub. Date: Apr. 13, 2006

(54) Reverse auction control method, computer program product, and server

(75) Inventor: Minako Murakami, Tokyo (JP)

Correspondence Address: EDWARDS & ANGELL, LLP, P.O. BOX 55874, BOSTON, MA, 02205, US

(73) Assignee: DeeCorp Limited, Tokyo (JP)

(21) Appl. No.: 11/212,531

(22) Filed: Aug. 25, 2005

(30) Foreign Application Priority Data
Aug. 25, 2004 (JP) 2004-244928

(51) Int. Cl. G06Q 40/00

(52) U.S. Cl. 705/37

(57) ABSTRACT

The server registers a plurality of supplier groups composed of one supplier or a combination of two or more suppliers so as to offer all items constituting a procurement object in a supplier group list. Then, it receives a bid price of a first supplier for an item included in the procurement object from a supplier terminal. Further, it selects the supplier group to which the first supplier belongs to with reference to the supplier group list and calculates a group bid price by summing up the bid prices of the suppliers belonging to the selected supplier group. Finally, it compares the calculated group bid price with the group bid prices of other supplier groups and determines a supplier group to be a candidate for the procurement object.

### BACKGROUND OF THE INVENTION

1. Field of the Invention

The present invention relates to control of reverse auction on a communication network and particularly to a reverse auction control method, program, and server that enable joint bid by a supplier group consisting of a combination of a plurality of suppliers.

2. Description of Related Art

Electronic purchase services that procure a product or service over the internet becomes common. Recently, B-to-B service that is intended for business-to-business transaction, not only B-to-C service that targets general consumers, is on the increase. One form of the electronic purchase service is a reverse auction service.

The reverse auction service starts upon buyer's presentation of desired procurement terms such as specifications of desired product or service item (which is referred to hereinafter simply as the item), price, quantity, delivery date, and delivery place. In this auction, suppliers who can satisfy the buyer's terms of procurement submit their bids. The supplier who has submitted the most favorable bid price, which is generally the lowest bid price, becomes a successful bidder. This is called “reverse auction” because roles of supplier and buyer are opposite from bid-up auction (forward auction) in which buyers submit bids in order to obtain an item presented by a supplier. The reverse auction that procures a product or service based on the buyer's purchase terms is suitable for business-to-business transaction since the terms of purchase such as specification requirements, delivery date, and delivery method are different from buyer to buyer in many cases. The system for implementing reverse auction on a communication network is disclosed in U.S. Pat. No. 5,794,207, Japanese Unexamined Patent Publication No. 2003-281409 and 2002-109286, for example.

When procuring an item from a supplier, a buyer sometimes intends to pursue bulk discount by making a bulk order of related items from the same supplier. However, if a procurement object that combines related product or service items is set as a procurement term, a supplier that can offer all the items included in the procurement object is limited to a large-scale supplier and thus a small-scale supplier cannot participate in the reverse auction. The same problem exists when setting a procurement term that requires delivering products to or offering services in bases throughout the nation. The suppliers that deal with limited items and the suppliers that have operational bases only in certain localities cannot offer all the procurement object items and thus cannot participate in the reverse auction.

To overcome the above drawbacks, it is desired to enable joint bid by a supplier group consisting of a plurality of small-scale suppliers or suppliers that have operational bases in certain localities for a procurement object that combines a plurality of items, thereby giving many suppliers opportunities to bid and promoting competition among suppliers, so that a buyer can procure the items with better terms.

### SUMMARY OF THE INVENTION

The present invention has been made to solve the above problems and an object of the present invention is thus to provide a reverse auction control method that enables joint bid by a supplier group consisting of a combination of a plurality of suppliers, a computer program product that causes a computer to execute the method, and a server.

According to one aspect of the invention, there is provided a control method of reverse auction executed by a server connected to a buyer terminal and a plurality of supplier terminals through a communication network. The method includes registering, in a group memory unit, a plurality of supplier groups composed of one supplier or a combination of two or more suppliers so as to offer all items constituting a procurement object; receiving a bid price of a first supplier for an item included in the procurement object from one of the supplier terminals; calculating a group bid price by adding the bid price of the first supplier and a bid price of another supplier included in a supplier group where the first supplier belongs with reference to the group memory unit; and determining a supplier group to be a candidate for the procurement object by comparing the calculated group bid price with a group bid price of another supplier group. Since this method allows determining a successful supplier by evaluating a bid price per supplier group that satisfies a procurement object including a plurality of items, it enables joint bid by a supplier group of a combination of a plurality of suppliers.

The registering step preferably includes receiving information of an item that the supplier desires to bid for and that is included in the procurement object from the supplier terminal; creating a plurality of supplier groups composed of one supplier or a combination of two or more suppliers so as to offer all items constituting the procurement object based on the information of the item that the supplier desires to bid for; and registering the plurality of supplier groups in the group memory unit. The server can thereby create a supplier group by determining the capability of offering all the items included in a procurement object by a combination of desired bid items.

The determining step preferably ranks supplier groups in ascending order of the group bid price and determines a supplier group with a lowest group bid price to be a successful supplier group for the procurement object.

It is also preferred that the method further includes notifying a rank of each supplier group determined in the determining step to each supplier terminal used by a supplier that belongs to each supplier group. Each supplier can thereby determine the competitiveness of own bid from the rank of the supplier group, which enhances submission of new bids by suppliers and increases the effect of reducing the group bid price. It is thereby possible to implement the joint bid by a supplier group as a combination of a plurality of suppliers.

According to another aspect of the invention, there is provided a computer program product for causing a computer connected to a buyer terminal and a plurality of supplier terminals through a communication network to execute a control process of reverse auction. The control process includes registering, in a group memory unit, a plurality of supplier groups composed of one supplier or a combination of two or more suppliers so as to offer all items constituting a procurement object; receiving a bid price of a first supplier for an item included in the procurement object from one of the supplier terminals; calculating a group bid price by adding the bid price of the first supplier and a bid price of another supplier included in a supplier group where the first supplier belongs with reference to the group memory unit; and determining a supplier group to be a candidate for the procurement object by comparing the calculated group bid price with a group bid price of another supplier group.

The registering step preferably includes receiving information of an item that the supplier desires to bid for and that is included in the procurement object from the supplier terminal; creating a plurality of supplier groups composed of one supplier or a combination of two or more suppliers so as to offer all items constituting the procurement object based on the information of the item that the supplier desires to bid for; and registering the plurality of supplier groups in the group memory unit. The server can thereby create a supplier group by determining the capability of offering all the items included in a procurement object by a combination of desired bid items.

The determining step preferably ranks supplier groups in ascending order of the group bid price and determines a supplier group with a lowest group bid price to be a successful supplier group for the procurement object.

It is also preferred that the control process further includes notifying a rank of each supplier group determined in the determining step to each supplier terminal used by a supplier that belongs to each supplier group. Each supplier can thereby determine the competitiveness of own bid from the rank of the supplier group, which enhances submission of new bids by suppliers and increases the effect of reducing the group bid price. It is thereby possible to implement the joint bid by a supplier group as a combination of a plurality of suppliers.

According to yet another aspect of the invention, there is provided a server connectable to a buyer terminal and a plurality of supplier terminals through a communication network and implementing control of reverse auction. The server includes a registration unit registering, in a group memory unit, a plurality of supplier groups composed of one supplier or a combination of two or more suppliers so as to offer all items constituting a procurement object; a receiving unit receiving a bid price of a first supplier for an item included in the procurement object from one of the supplier terminals; a calculation unit calculating a group bid price by adding the bid price of the first supplier and a bid price of another supplier included in a supplier group where the first supplier belongs with reference to the group memory unit; and a determination unit determining a supplier group to be a candidate for the procurement object by comparing the calculated group bid price with a group bid price of another supplier group.

The registration unit preferably receives information of an item that the supplier desires to bid for and that is included in the procurement object from the supplier terminal, creates a plurality of supplier groups composed of one supplier or a combination of two or more suppliers so as to offer all items constituting the procurement object based on the information of the item that the supplier desires to bid for, and registers the plurality of supplier groups in the group memory unit. The server can thereby create a supplier group by determining the capability of offering all the items included in a procurement object by a combination of desired bid items.

Preferably, the determination unit ranks supplier groups in ascending order of the group bid price and determines a supplier group with a lowest group bid price to be a successful supplier group for the procurement object.

It is also preferred that the server further includes a notification unit notifying a rank of each supplier group determined in the determining step to each supplier terminal used by a supplier that belongs to each supplier group. Each supplier can thereby determine the competitiveness of own bid from the rank of the supplier group, which enhances submission of new bids by suppliers and increases the effect of reducing the group bid price. It is thereby possible to implement the joint bid by a supplier group as a combination of a plurality of suppliers.

The present invention can provide a reverse auction control method that enables joint bid by a supplier group consisting of a combination of a plurality of suppliers, a computer program product that causes a computer to execute the method, and a server.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is an entire block diagram of a reverse auction system of a first embodiment of the invention;

FIG. 2 is a block diagram of a server;

FIG. 3 is an example of a procurement object table;

FIG. 4 is an example of a procurement item table;

FIG. 5 is an example of a participating supplier information table;

FIG. 6 is an example of a supplier group list;

FIG. 7 is a process flow diagram of a reverse auction system;

FIG. 8 is a view showing an example of a reverse auction participation registration screen;

FIG. 9 is a process flow diagram of a supplier group creation process;

FIG. 10 is a process flow diagram of reverse auction;

FIG. 11 is an example of a bid price table;

FIG. 12 is an example of a group ranking list;

FIG. 13 is a view showing an example of a display screen of a supplier terminal;

FIGS. 14A and 14B are views showing examples of a display screen of a supplier terminal; and

FIGS. 15A and 15B are views showing examples of a display screen of a buyer terminal.

### DESCRIPTION OF THE PREFERRED EMBODIMENTS

### First Embodiment

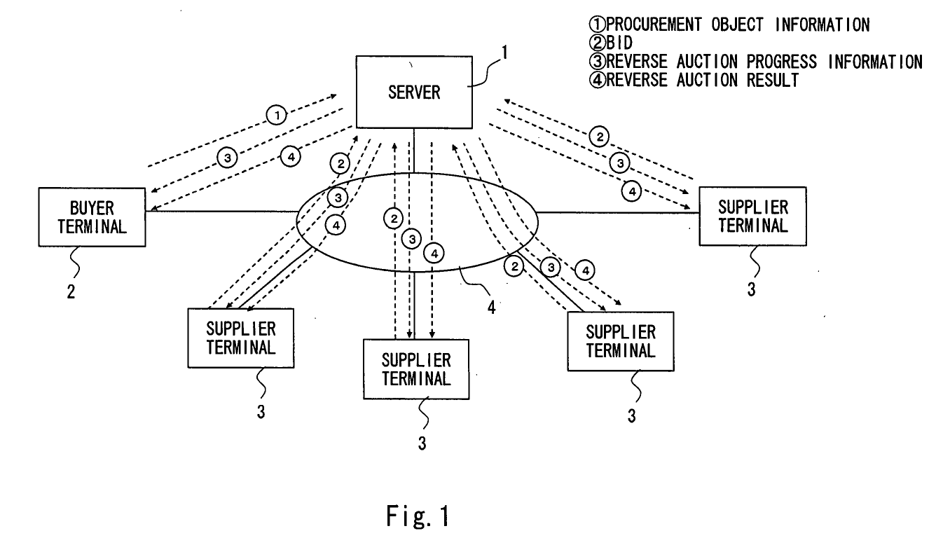

FIG. 1 is the entire block diagram of a reverse auction system of a first embodiment of the invention. The system has a server 1, one or more buyer terminal 2, and one or more supplier terminal 3, which are connected over the network 4.

The server 1 acquires and controls information about a procurement object that is transmitted from the buyer terminal 2 and bidding information that is transmitted from the supplier terminal 3, and implements reverse auction. The buyer terminal 2 is used by a buyer who is a user of the reverse auction service. The supplier terminal 3 is used by a supplier who is also a user of the reverse auction service. The buyer is a purchaser who desires to procure items through the use of the reverse auction service. The supplier is a seller who desires to offer items to a buyer.

An overview of the operation of the reverse auction system according to this embodiment is described hereinafter with reference to FIG. 1. Firstly, the buyer terminal 2 transmits procurement object information about reverse auction target items to the server 1. The procurement object information contains information such as detailed specification of items to be procured in the reverse auction, total procurement amount, delivery date, and delivery place. The procurement object information may further contain a scheduled reverse auction date and a reverse auction starting price. The procurement object information thus contains terms to be specified by a buyer when holding reverse auction.

Then, the server 1 selects a combination of suppliers that can offer all the items desired by the buyer and thereby creates a supplier group consisting of one supplier or a combination of two or more suppliers.

After that, the server 1 implements the reverse auction. The server 1 combines bid prices submitted by suppliers that are contained in the bid information transmitted from the supplier terminals 3 and calculates a total bid price (group bid price) of the supplier group. Then, it compares the calculated group bid prices among supplier groups to rank the supplier groups. The bid information at least contains an evaluation parameter required for ranking the bids. The evaluation parameter is typically a bid price. Another evaluation parameter such as a price per unit quantity of an item may be used.

Further, the server 1 transmits the progress of the reverse auction and the information to display a final result of the reverse auction to the buyer terminal 2 and the supplier terminal 3. The buyer terminal 2 and the supplier terminal 3 display the information on display means such as a CRT display and a LCD.

In this process, the reverse auction system of this embodiment conducts the reverse auction that enables joint bid by a supplier group consisting of a plurality of suppliers. The devices constituting the reverse auction system of this embodiment, program, and the flow of the reverse auction of this embodiment are described below. The following description describes a case where a reverse auction object item includes a plurality of different items, and an evaluation parameter for ranking suppliers is a bid price.

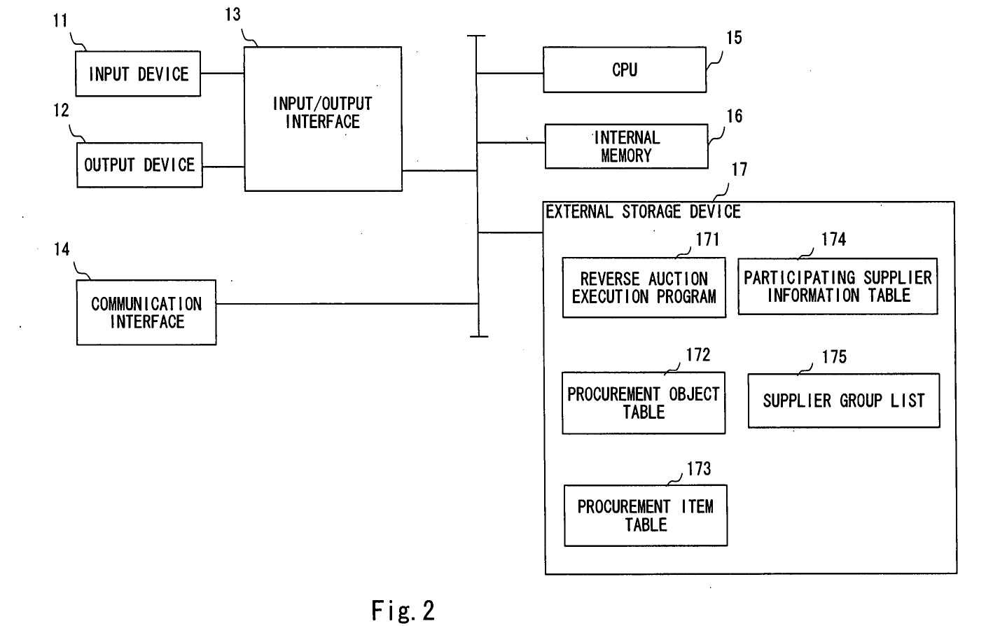

FIG. 2 shows the hardware configuration of the server 1. The server 1 may be composed of a typical computer system. For example, the server 1 includes an input device 11 such as a keyboard and a mouse, an output device 12 such as a monitor and a printer, an input/output interface 13 for controlling their input and output, and a communication interface 14 for transmitting and receiving data through a network such as LAN, telephone network, packet exchange network. The server 1 further includes a CPU 15 for executing arithmetic processing, an internal memory 16, and an external storage device 17. The external storage device 17 is a hard disk device, for example, which is placed in the same computer together with other components. Instead, it may be a physically separated database or a combination of a plurality of hard disks or databases.

The CPU 15 is a central control unit that executes each processing in the server 1 according to control program. The control program is a program for causing the CPU 15 to execute the processing on the server 1, and it is stored in the internal memory 16 or the external storage device 17. The program may be acquired from remote memory through the communication network.

The external storage device 17 stores reverse auction execution program 171, procurement object table 172, procurement item table 173, participating supplier information table 174, and supplier group list 175.

The reverse auction execution program 171 causes the computer system to implement the reverse auction control of this invention. It is loaded to the internal memory 16 and executed on the CPU 15. The CPU 15 operates according to the reverse auction execution program 171, thereby allowing the computer system to operate as the server 1 of this embodiment.

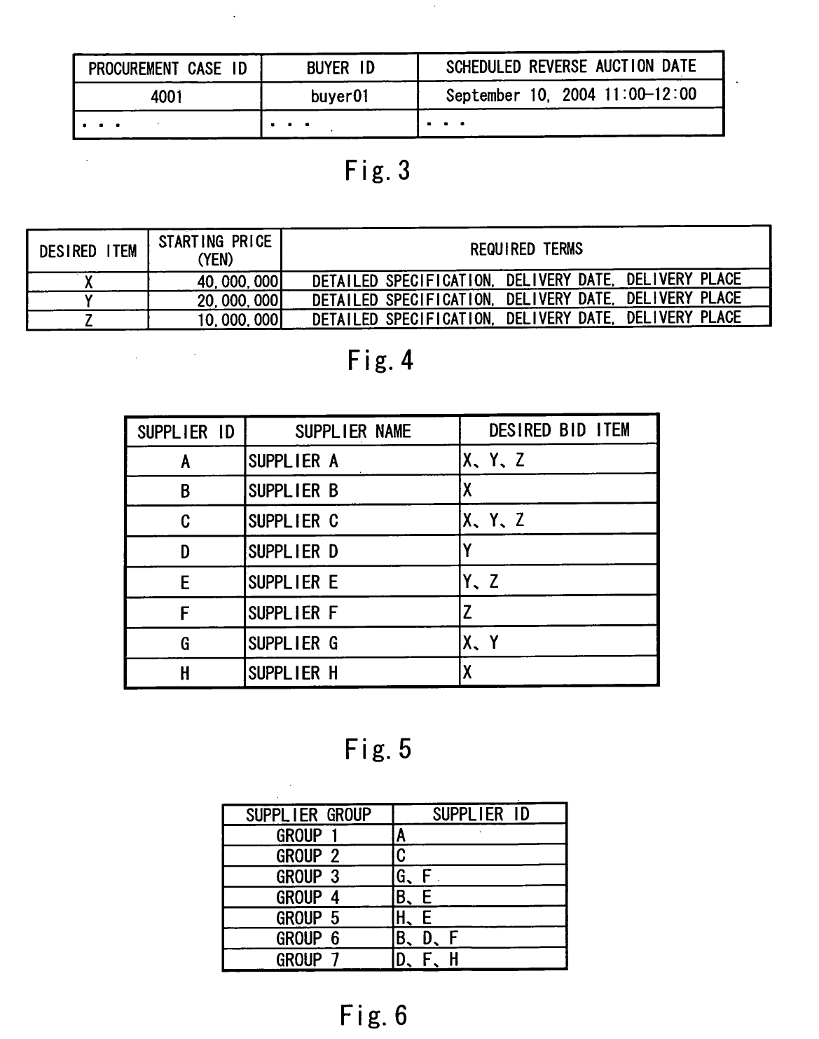

The procurement object table 172 and the procurement item table 173 store information contained in the procurement object information transmitted from the buyer terminal 2 in association with a procurement object ID as an identifier of a reverse auction case. FIGS. 3 and 4 show examples of the procurement object table 172 and the procurement item table 173, respectively. As shown in FIG. 3, the procurement object table 172 stores information containing a buyer ID of a buyer who intends to procure an item and a scheduled reverse auction date for each procurement object ID assigned to each procurement object. The procurement item table 173 stores information containing required terms such as the name of an item to be procured, a reverse auction starting price, a detailed specification of a procurement item, a delivery date, and a delivery place. Since the procurement object information stored in the procurement object table 172 and the procurement item table 173 is determined mainly according to the buyer's intention as reverse auction starting terms, it is preferably supplied from the buyer terminal 2. Instead, it may be input by a reverse auction administrator through the input device 11 and stored into the internal memory 16 or the external storage device 17 through the input/output interface 13. The point is that the procurement object information is stored prior to the start of reverse auction in such a way that the server 1 can refer to it.

The participating supplier information table 174 stores the name of suppliers who intend to participate in the reverse auction and items they desire to bid for. FIG. 5 is an example that shows participating suppliers and items for which each supplier desires to bid for (desired bid items) for items X, Y, and Z contained in the procurement item table 173 of FIG. 4. In order to associate the procurement object and the participating supplier information table 174, the participating supplier information table 174 may store information in association with a procurement object ID. A process of registering a participating supplier in the participating supplier information table 174 may receive supplier's intention of participation in the reverse auction and a desired bid item from the supplier terminal 3 and register the supplier who intends to participate in the participating supplier information table 174 based on this information.

The supplier group list 175 is group memory unit that stores supplier groups and suppliers included in each supplier group in association with each other. The supplier group is a group of suppliers combined so as to enable to offer all the items which a buyer desires to procure. It is created by selecting suppliers from the participating supplier information table 174 and combining them. FIG. 6 shows a supplier group list that is created based on the participating supplier information table 174 of FIG. 5. A combination of suppliers is made so that a group can offer all the buyer's desired items X, Y, and Z. For example, since a supplier A can offer all the desired items, it constitutes one supplier group (group 1) alone. On the other hand, a supplier B that can offer the item X and a supplier E that can offer the items Y and Z are combined to constitute one supplier group (group 4). A specific process flow to create a supplier group is described later.

The buyer terminal 2 is a personal computer (PC), for example, which includes CPU, ROM, RAM, hard disk, display, keyboard, mouse, and so on. The buyer terminal 2 exchanges data with the server 1 and displays the progress and final result of reverse auction by executing Web browser program stored in the hard disk, for example, using TCP/IP, HTTP protocol.

The supplier terminal 3 is also a PC, for example, which includes CPU, ROM, RAM, hard disk, display, keyboard, mouse, and so on. The supplier terminal 3 exchanges data with the server 1 and displays the progress and final result of reverse auction by executing Web browser program stored in the hard disk, for example.

The network 4 is a communication network such as internet, public network, leased line, and mobile communication network.

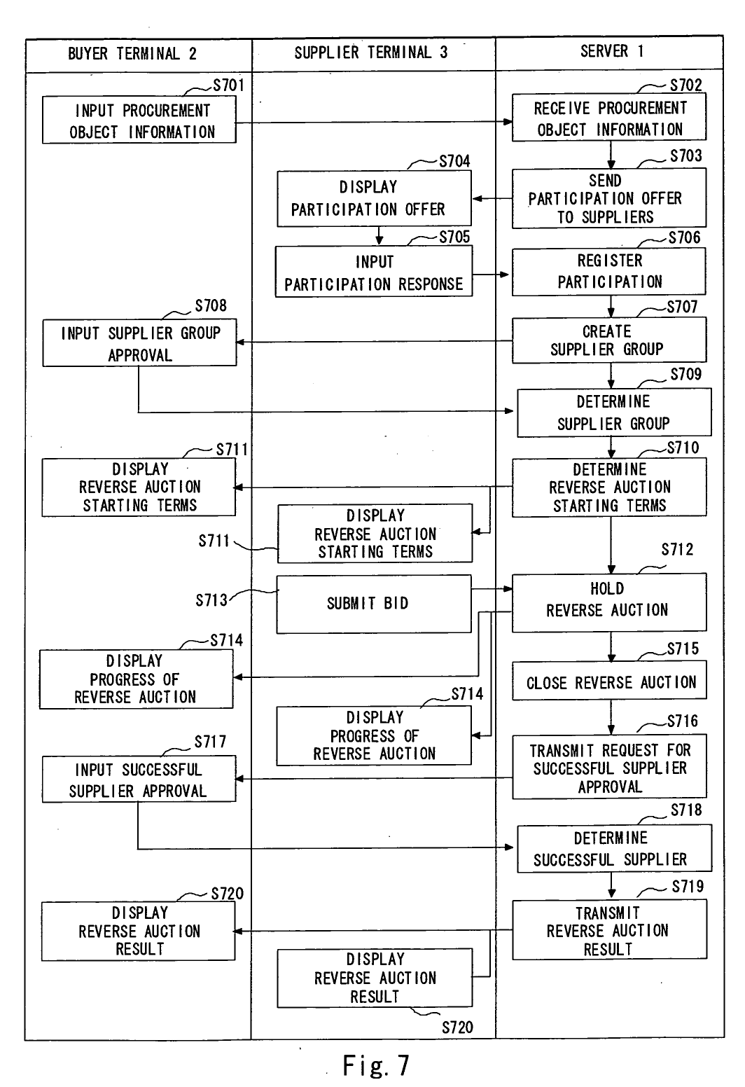

The process flow of the reverse auction of this embodiment is described hereafter with reference to FIG. 7. The operation of the server 1 described below is executed by the CPU 15 which operates in collaboration with other hardware resources according to the reverse auction execution program 171.

First, the buyer terminal 2 accepts input of procurement object information by a buyer and transmits the input procurement object information to the server 1 (S701). Then, the server 1 receives the procurement object information from the buyer terminal 2 through the communication interface 13 and stores it into the procurement object table 172 and-the procurement item table 173 in the external storage device 17 (S702).

Then, the server 1 transmits a notice of invitation to participate in the reverse auction to the supplier terminal 3 (S703). At this time, the server 1 also transmits to the supplier terminal 3 the information about the reverse auction case such as specification of a procurement object item and a reverse auction starting price, which is stored in the procurement object table 172 and the procurement item table 173. Instead, the supplier who has received the invitation notice may access the server 1 through the supplier terminal 3 to browse the information about the reverse auction case. A buyer may specify the supplier to receive the invitation notice or the server 1 may select the supplier who has the potential of participation by referring to database or the like that stores past purchase records and transmit the notice. Further, the server 1 may inform the buyer terminal 2 of the selected suppliers having the potential of participation and give notice of invitation to the suppliers who are approved by the buyer. Furthermore, the server 1 may previously accept registration of suppliers who are interested in the reverse auction and retain it in the external storage device 17 or the like as supplier candidate data file. Then, the server 1 may select appropriate suppliers from this data file and gives invitation notice to them.

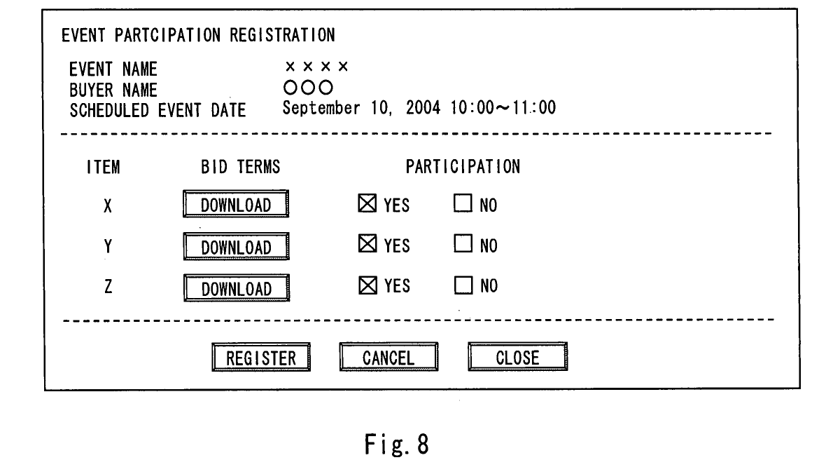

The supplier terminal 3 displays the received participation invitation notice in a display or the like (S704). FIG. 8 shows an example of a participation invitation screen displayed in the supplier terminal 3. It presents basic information such as the name of a procurement object (event name), the name of a buyer who is to procure an item, a scheduled reverse auction date (scheduled event data) and also information about a procurement object item. It is preferred that detailed information (bid terms) such as the specification of each item and delivery date is acquired from the server 1 by pressing a download button as shown in FIG. 8.

The supplier terminal 3 then accepts input of a participation response for each desired bid item from a supplier who desires to participate in the reverse auction and transmits the response to the server 1 (S705). In the participation invitation screen shown in FIG. 8, a supplier can specify a desired bid item by marking participation or nonparticipation for each item. The server 1 receives the participation response from the supplier terminal 3 and registers the supplier who has transmitted the participation response and the desired bid item into the participation supplier information table 174 (S706).

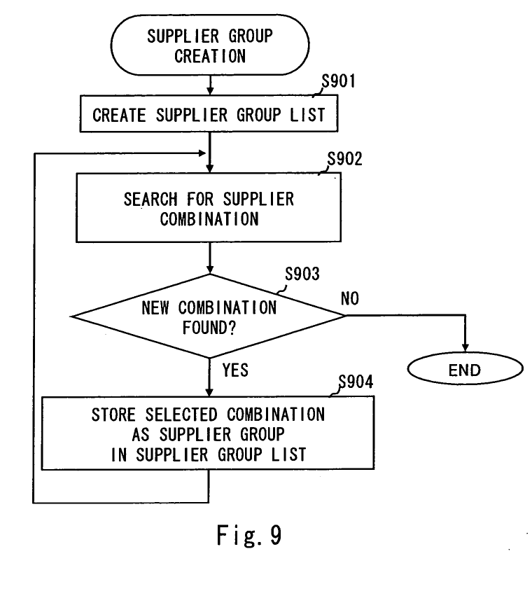

After that, the process creates supplier groups and transmits an approval request for the created supplier groups to the buyer terminal 2 (S707). A detailed flow of the supplier group creation process is described with reference to FIG. 9. First, the process creates a supplier group list 175 (S901). Then, it searches for a combination of suppliers that enables to offer all the items that the buyer desires to procure by referring to desired bid items of each supplier that are registered in the participating supplier information table 174. If a combination of suppliers that enables to offer all the procurement object items is newly selected, it registers this combination as a new supplier group in the supplier group list 175 (S903 and S904), and then searches for a new combination of suppliers. If no new combination is found, the supplier group creation process ends.

Referring back to FIG. 7, the buyer terminal 2 displays the supplier group approval request transmitted from the server 1 so that a buyer inputs approval (S708). The approval information input by the buyer is transmitted to the server 1, thereby fixing the supplier group list 175 used for the reverse auction based on the buyer's approval information (S709). On the other hand, if the buyer denies the participation of a specific supplier group, the server 1 receives the information about the denied supplier group together with the approval information from the buyer terminal 2 and eliminates the denied supplier group from the supplier group list 175, thereby fixing the supplier group list 175.

Then, the process determines reverse auction starting terms based on the procurement object information, participating supplier information, and supplier groups obtained in the foregoing steps, and transmits the reverse auction starting terms to the buyer terminal 2 of the participating buyer and the supplier terminals 3 of the participating suppliers (S710). The starting terms include a scheduled reverse auction date, a starting price, and so on. The buyer terminal 2 and the supplier terminal 3 display the reverse auction starting terms transmitted from the server 1 for a buyer and a supplier, respectably (S711).

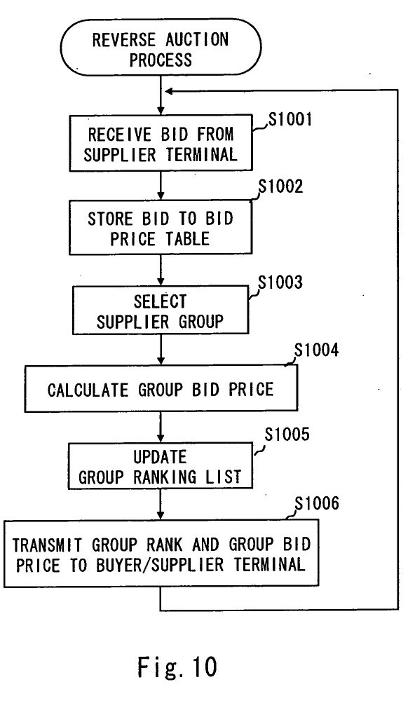

After that, the server 1 implements reverse auction on the scheduled reverse auction date stored in the procurement object table 172 (S712). The supplier terminal 3 accepts a bid from a supplier and transmits the information to the server 1 (S713). The detail of the reverse auction process executed in the server 1 is described hereinafter with reference to FIGS. 10 to 15.

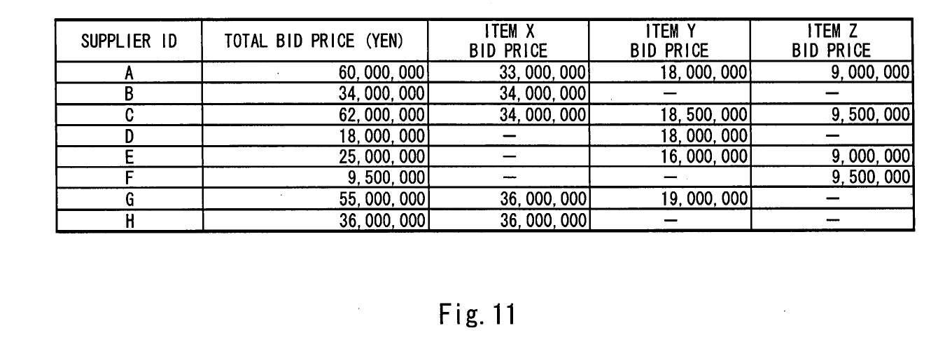

In the reverse auction process, the server 1 first receives bid data from the supplier terminal 3 (S1001). The bid data at least contains a bid price. The received bid data is stored in a bid price table retained in the internal memory 16 (S1002). The bid data may be stored in the external storage device 17 in order to back up the data or retain the bid history. FIG. 11 shows an example of the bid price table. The bid price table stores a bid price per item and a total bid price that is a sum of bid prices per item.

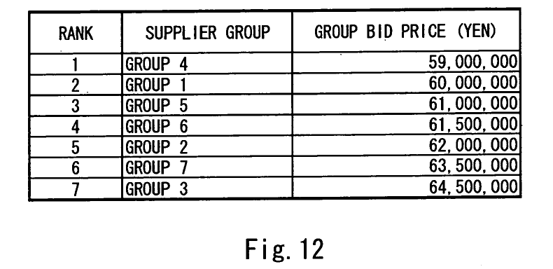

Then, the server 1 selects the supplier group to which the supplier corresponding to the received bid belongs by referring to the supplier group list 175 (S1003). Further, the server 1 calculates a group bid price that is a sum of bid prices of all the suppliers belonging to the supplier group by referring to the above bid price table (S1004). The supplier 1 then compares the group bid price calculated in the previous step with the group bid prices of other supplier groups and updates a group ranking list (S1005). The group ranking list is a list that ranks the supplier groups in ascending order of the group bid price. It stores the group bid price in association with the supplier group name or its identification information. The list is retained in the internal memory 16 or the external storage device 17 at least during the reverse auction. FIG. 12 shows an example of the group ranking list. Since the group 4 submits the lowest bid price in this example, the suppliers who belong to the group 4 are candidates for successful bidder at the present moment. The suppliers who belong to the group 4 can be found by referring to the supplier group list 175.

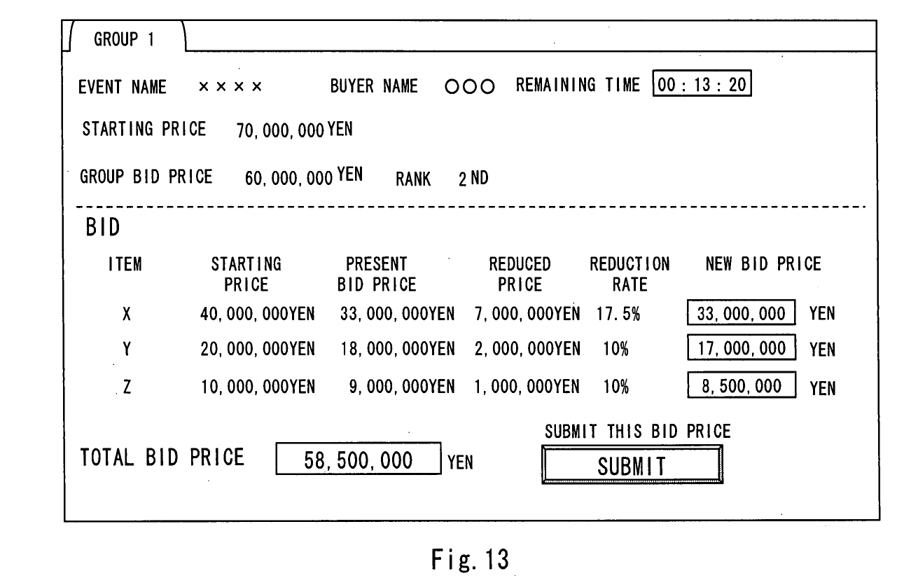

Finally, the server 1 transmits progress information of the reverse auction to the buyer terminal 2 and the supplier terminal 3 (S1006). FIGS. 13 to 15 show examples of display screens of the buyer terminal 2 and the supplier terminal 3, which display data based on the transmitted progress information. FIG. 13 shows an example of a display screen of the progress information to a supplier, which is a display screen for the supplier A who belongs to the supplier group 1 in the supplier group list 175 of FIG. 6. It shows basic information such as a procurement object name, a procurement buyer name and a remaining bid time, a present group bid price of the group 1, a reduced price from the starting price, a reduction rate, and a group rank. Further, the screen has a bid price per biddable item and an input field of a new bid price so as to accept new bid submission. Since the supplier A constitute a supplier group alone, the group bid price and the bid price submitted by the supplier A are the same.

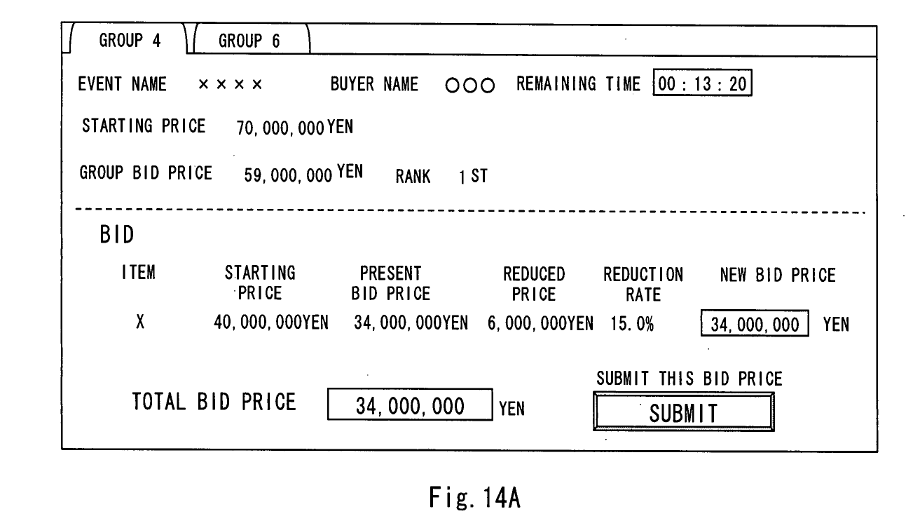

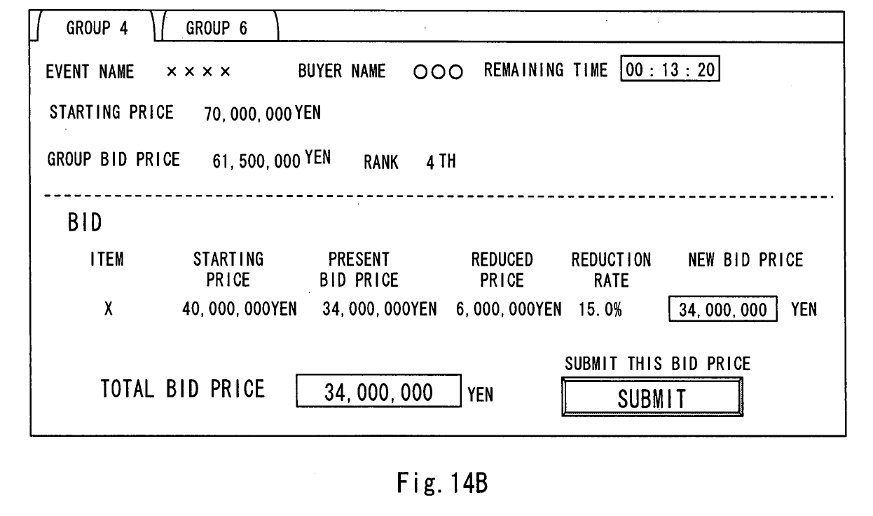

FIGS. 14A and 14B show examples of display screens for the supplier B that belongs to the supplier groups 4 and 6 in the supplier group list 175 of FIG. 6. FIG. 14A is the screen about the group 4 and FIG. 14B is the screen about the group 6. These examples show that the supplier B submits the bid price of 34 million yen for the biddable item X. The group 4 is in the first place and the group 6 is in the fourth place of the ranking. The group bid price is calculated by adding the bid price of the supplier B and the bid prices of the other suppliers, and the group's rank is determined based on the group bid price. Thus, though the bid submitted by the supplier B is one (the bid price of 34 million yen), the group bid price and its rank vary according to the bid prices of the other suppliers. A change in the group bid price and the group rank is reflected in the screen as needed.

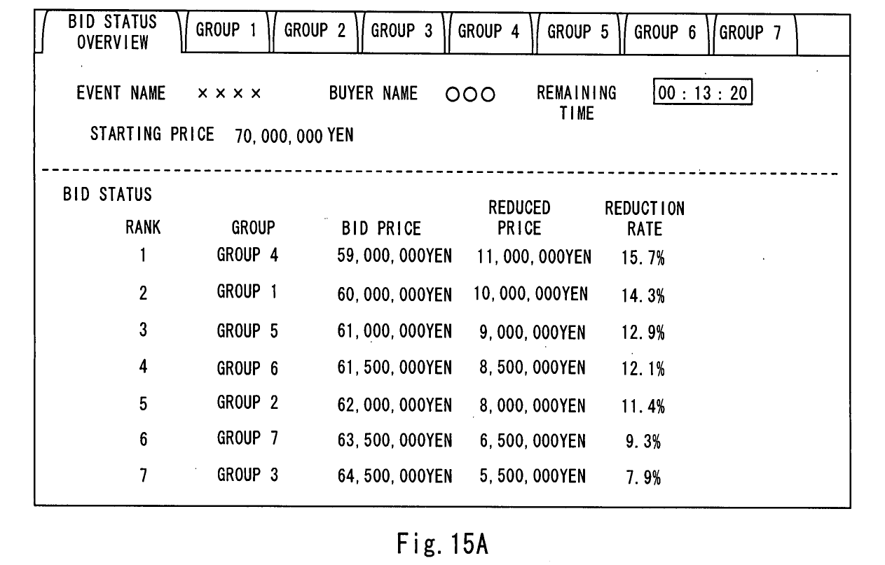

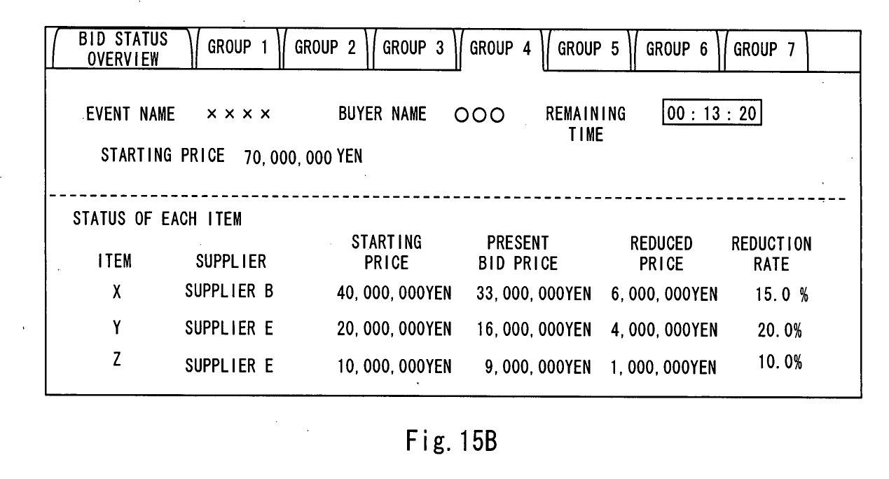

FIGS. 15A and 15B show examples of the display screen of the buyer terminal 2. FIG. 15A is an example of a bid state list screen to show the ranks, group bid prices, reduced amounts from a starting price, and reduction rates of all supplier groups. FIG. 15B is an example of a screen to show the state of the bid price per item for each supplier.

The reverse auction process of the steps S712 ends at a predetermined auction close time (S715). It is, however, possible to extend the auction close time if the reverse auction is heated up.

After the reverse auction is closed, the server 1 transmits a request for approving the successful supplier to the buyer terminal 2 (S716). The buyer terminal 2 receives an approval by the buyer and transmits it to the server 1 (S717). After receiving the buyer's approval, the server 1 determines the final successful supplier (S718) Since the buyer performs comprehensive evaluation that considers not only a bid price but also other evaluation items when procuring direct material or the like in some cases, the server 1 preferably determines the successful supplier after receiving the approval of the successful supplier group by the buyer.

It is also feasible that the server 1 calculates, prior to S716, the group bid price of the supplier group that has been denied by the buyer in S708. If the calculated group bid price is lower than the group bid price of the participating supplier group, the server 1 may transmit the group bid price of this group also to the buyer terminal 2 in S716 so as to receive approval of the buyer whether to determine the supplier group denied in S708 as a successful supplier group in S717.

Finally, the server 1 transmits reverse auction result information containing a determined contract price and a successful supplier to the buyer terminal 2 (S719). The buyer terminal 2 then displays the received reverse auction result for the buyer (S720) The server 1 also transmits the reverse auction result information such as a determined supplier rank to the supplier terminal 3. The supplier terminal. 3 displays the received reverse auction result for the participating supplier.

If the server 1, the buyer terminal 2, the supplier terminal 3 operate according to the process flow described above, it is possible to implement reverse auction that enables joint bid by a supplier group that combines a plurality of suppliers and determines a successful supplier based on the group bid price calculated from a bid price of each supplier.

Though the above description describes the case that enables bidding per item for procurement object that includes a plurality of different kinds of items to simplify the description, it is possible to divide the bid unit into more specific pieces. For example, if the supplier that can offer an item to all delivery places is limited since delivery places are located nationwide, it is possible to divide the delivery place of one item to enable bid per divided area, thereby allowing participation of suppliers having operational bases only in certain localities or the like. Specifically, the one that one item is divided according to each delivery place, such as an item X(area L), an item X (area M), and an item X (area N), may constitute each reverse auction object item, and a supplier group may be created based on the supplier's intention to bid for each divided item.

Further, though this embodiment describes the case where the reverse auction execution program 171 is stored in the external storage device 17 such as a hard disk, the program may be stored in a variety of storage media or transmitted through a communication medium. The storage media include a flexible disk, hard disk, magnetic disk, magnetic optical disk, CD-ROM, DVD, ROM cartridge, RAM memory cartridge with battery backup, flash memory cartridge, nonvolatile RAM cartridge, and so on, for example. The communication media include wired communication media such as a telephone line and wireless communication media such as a microwave line, including internet.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A control method of reverse auction executed by a server connected to a buyer terminal and a plurality of supplier terminals through a communication network, the method comprising:
registering, in a group memory unit, a plurality of supplier groups composed of one supplier or a combination of two or more suppliers so as to offer all items constituting a procurement object;
receiving a bid price of a first supplier for an item included in the procurement object from one of the supplier terminals;
calculating a group bid price by adding the bid price of the first supplier and a bid price of another supplier included in a supplier group where the first supplier belongs with reference to the group memory unit; and
determining a supplier group to be a candidate for the procurement object by comparing the calculated group bid price with a group bid price of another supplier group.

2. The control method of reverse auction according to claim 1, wherein the registering step comprises:
receiving information of an item that the supplier desires to bid for and that is included in the procurement object from the supplier terminal;
creating a plurality of supplier groups composed of one supplier or a combination of two or more suppliers so as to offer all items constituting the procurement object based on the information of the item that the supplier desires to bid for; and
registering the plurality of supplier groups in the group memory unit.

3. The control method of reverse auction according to claim 1, wherein the determining step ranks supplier groups in ascending order of the group bid price and determines a supplier group with a lowest group bid price to be a successful supplier group for the procurement object.

4. The control method of reverse auction according to claim 3, further comprising:
notifying a rank of each supplier group determined in the determining step to each supplier terminal used by a supplier that belongs to each supplier group.

5. The control method of reverse auction according to claim 1, wherein at least one supplier belongs to two or more supplier groups contained in the plurality of supplier groups which are generated in the registering step.

6. The control method of reverse auction according to claim 1, wherein the registering step comprises:
transmitting a approval request to approve the plurality of supplier groups to the buyer terminal;
receiving a approval information for the approval request from the buyer terminal; and
eliminating a supplier group denied by the buyer from the group memory unit based on the approval information.

7. The control method of reverse auction according to claim 6, wherein the determining step further comprises:
determining the supplier group to be a candidate for the procurement object by comparing the calculated group bid price with a group bid price of the supplier group denied by the buyer.

8. A computer program product for causing a computer connected to a buyer terminal and a plurality of supplier terminals through a communication network to execute a control process of reverse auction, the control process comprising:
registering, in a group memory unit, a plurality of supplier groups composed of one supplier or a combination of two or more suppliers so as to offer all items constituting a procurement object;
receiving a bid price of a first supplier for an item included in the procurement object from one of the supplier terminals;
calculating a group bid price by adding the bid price of the first supplier and a bid price of another supplier included in a supplier group where the first supplier belongs with reference to the group memory unit; and
determining a supplier group to be a candidate for the procurement object by comparing the calculated group bid price with a group bid price of another supplier group.

9. The computer program product according to claim 8, wherein the registering step comprises:
receiving information of an item that the supplier desires to bid for and that is included in the procurement object from the supplier terminal;
creating a plurality of supplier groups composed of one supplier or a combination of two or more suppliers so as to offer all items constituting the procurement object based on the information of the item that the supplier desires to bid for; and
registering the plurality of supplier groups in the group memory unit.

10. The computer program product according to claim 8, wherein the determining step ranks supplier groups in ascending order of the group bid price and determines a supplier group with a lowest group bid price to be a successful supplier group for the procurement object.

11. The computer program product according to claim 10, wherein the control process further comprises:
notifying a rank of each supplier group determined in the determining step to each supplier terminal used by a supplier that belongs to each supplier group.

12. The computer program product according to claim 8, wherein at least one supplier belongs to two or more supplier groups which are generated in the registering step.

13. A server connectable to a buyer terminal and a plurality of supplier terminals through a communication network and implementing control of reverse auction, the server comprising:
a registration unit registering, in a group memory unit, a plurality of supplier groups composed of one supplier or a combination of two or more suppliers so as to offer all items constituting a procurement object;
a receiving unit receiving a bid price of a first supplier for an item included in the procurement object from one of the supplier terminals;
a calculation unit calculating a group bid price by adding the bid price of the first supplier and a bid price of another supplier included in a supplier group where the first supplier belongs with reference to the group memory unit; and
a determination unit determining a supplier group to be a candidate for the procurement object by comparing the calculated group bid price with a group bid price of another supplier group.

14. The server according to claim 13, wherein the registration unit receives information of an item that the supplier desires to bid for and that is included in the procurement object from the supplier terminal, creates a plurality of supplier groups composed of one supplier or a combination of two or more suppliers so as to offer all items constituting the procurement object based on the information of the item that the supplier desires to bid for, and registers the plurality of supplier groups in the group memory unit.

15. The server according to claim 13, wherein the determination unit ranks supplier groups in ascending order of the group bid price and determines a supplier group with a lowest group bid price to be a successful supplier group for the procurement object.

16. The server according to claim 15, further comprising:
a notification unit notifying a rank of each supplier group determined in the determining step to each supplier terminal used by a supplier that belongs to each supplier group.

17. The server according to claim 13, wherein at least one supplier belongs to two or more supplier groups which are generated by the registration unit.
